(19) United States
(12) Patent Application Publication
(10) Pub. No.: US 2025/0205763 A1
(43) Pub. Date: Jun. 26, 2025

(54) SYSTEM AND METHOD FOR REMEDIATING OIL CONTAMINATED SOIL

(71) Applicant: Amerapex Corporation, Houston, TX (US)

(72) Inventors: Daniel BARNES, Houston, TX (US); Charles Mitchell MEANS, Houston, TX (US); Remy KALAI, Houston, TX (US); Steve WALKER, Houston, TX (US)

(73) Assignee: Amerapex Corporation, Houston, TX (US)

(21) Appl. No.: 18/999,650

(22) Filed: Dec. 23, 2024

Related U.S. Application Data
(60) Provisional application No. 63/614,883, filed on Dec. 26, 2023.

(51) Int. Cl. B09C 1/08

(52) U.S. Cl. CPC B09C 1/08

(57) ABSTRACT

Soil contaminated with oil can be treated to remediate the soil for safe use in agriculture and construction. The soil is remediated by employing a system comprising a shredder, at least one sand screw, and a separator. The system employs a metallic catalyst and a chemical oxidant, the chemical oxidant often being hydrogen peroxide. The contaminated soil is separated from the organic contaminates, and the organic contaminated can be discarded or recycled.

### CROSS-REFERENCE TO RELATED APPLICATIONS

This application claims priority to and benefit of U.S. Provisional Patent Application No. 63/614,883 filed on Dec. 26, 2023 (Docket No. AMPX-1006-P). This application incorporates the provisional application by reference in its entirety into this document as if fully set out at this point.

### BACKGROUND OF THE INVENTION

### Field of the Invention

The invention relates to the remediation of soil. The invention particularly relates to remediation of soil that has been contaminated with crude oil.

### Background of the Art

Oil spills on land have long been a problem with the production of oil and gas. It is known that once spilled, oil can degrade in as little as a few weeks or take decades to decompose. In some instances, if enough oil is spilled, it can persist indefinity. This is mostly a function of the type oil spilled and how much oil is spilled. Heavier oil and tars are especially persistent in soil.

For example, during the retreat of the Iraqi army from Kuwait in 1991, a large number of oil wells were deliberately destroyed resulting in massive oil spills. 30 years later it is still a problem in Kuwait. It would be desirable in the art to be able to remediate oil contaminated soil quickly and economically.

The traditional method of remediation is known as the Mechanical (Dig and Haul) is a technique. It is commonly used in environmental remediation to remove contaminated soil, sediment, or other materials from a site. It involves digging out the contaminated material and transporting it to a licensed disposal facility for proper disposal. The disadvantages of this process are obvious. Digging and hauling are very energy intensive. The cost of preparing a repository is very high as well.

It would be desirable in the art to treat oil contaminated soil and remove the oil leaving an environmentally acceptable soil. Such soil can be used in agriculture and construction.

### SUMMARY OF THE INVENTION

In one aspect, the invention is a system for remediating contaminated soil including a shredder, a sand screw, and a separator wherein: the shredder is configured to: receive a feed stream of contaminated soil; introduce a metal catalyst and chemical oxidant into the shredder; and feed the contaminated soil into the sand screw. The sand screw is configured to: receive a feed stream of partially treated contaminated soil; receive a feed stream of chemical oxidant; receive a feed stream of water and/or chemical additive; and feed the contaminated soil into the separator. The separator is configured to: separate the contaminated soil fed into it into at least a treated soil stream and organic solids and/or liquids stream.

In another aspect, the invention is a process for remediating contaminated soil by employing a system including a shredder, a sand screw, and a separator wherein: the shredder is configured to: receive a feed stream of contaminated soil; introduce a metal catalyst and chemical oxidant into the shredder; and feed the contaminated soil into the sand screw. The sand screw is configured to: receive a feed stream of partially treated contaminated soil; receive a feed stream of chemical oxidant; receive a feed stream of water and/or chemical additive; and feed the contaminated soil into the separator. The separator is configured to: separate the contaminated soil fed into it into at least a treated soil stream and organic solids and/or liquids stream.

In yet another aspect, the invention is the same that of the prior paragraph except employing a second sand screw to remediate the contaminated soil.

### BRIEF DESCRIPTION OF THE DRAWING

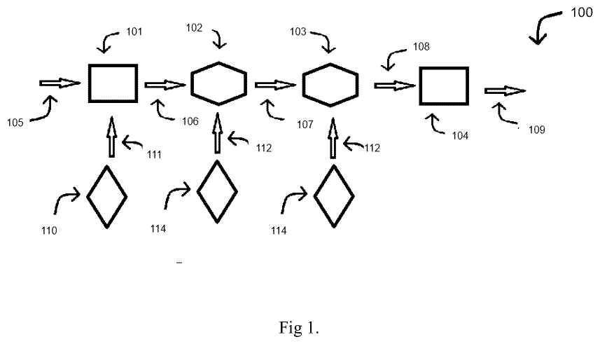

The above and other features and advantages of the present invention will become more apparent by describing in detail embodiments thereof with reference to the drawings wherein FIG. 1 is an illustration of an embodiment of a system of the application.

### DESCRIPTION OF THE PREFERRED EMBODIMENTS

Generally speaking, the invention is an improvement to the art of remediating oil contaminated soils which includes combining multiple methods of separating oil contamination from the contaminated soil. The methods work together to get a synergistic result, namely the production of soil that can be used for agriculture or construction.

In one embodiment, the invention is a system having multiple components that perform the methods of remediating the contaminated soils. In a first embodiment, the first component is a shredder fed by a hopper system. The hopper may be manually set depending on the application rate needed. In other embodiments, the hopper may be set using a controller set to control the whole system.

In an alternative embodiment, the first component is a shredder having an integrated hopper system. In both embodiments, the shredder receives the contaminated soil and then both mixes it with a metal catalyst and combines it with a chemical oxidant; while also grinding the contaminated soil to reduce the size of paraffins and tar balls that may be present to size sufficiently small to allow for enhanced remediation.

The shredder may have points of application (hereinafter applicators) for the introduction of the metal catalysts and the chemical oxidants. The applicators may be spray nozzles, screw feeders, or any other devices that allows for the introduction of the chemical oxidants and metal catalysts known to be useful to those of ordinary skill in the art of treating contaminated soils. Hereinafter, the term “to those of ordinary skill in the art of treating contaminated soils” shall be referred to as those of “ordinary skill.”

In many real-world instances of employing the systems of the application to treat contaminated soil, there will be a need to introduce a metal catalyst, it is possible in some situations where the metal catalyst may already be present in the contaminated soil.

Where there is a need for the metal catalyst, it can be desirably employed in form that is both easy to handle and economical to purchase. For example, two metals which can be used together or alone are Iron and potassium. One easily handled form of these metals is commercial fertilizer such as 1-0-1 (a combined form) or 1-0-0 (iron only). Any iron catalyst known to those of ordinary skill in the art can be used with the systems of the application.

Chemical oxidants useful with the systems of the application should similarly be easy to handle and economical to purchase. In most embodiments of the application, hydrogen peroxide is a desirable chemical oxidant. Of course, other oxidants can be used. For example, phosphoric acid could be used in some embodiments. Ozone and bleaches like sodium hypochlorite may be used. Any chemical oxidants known to those of ordinary skill in the art can be used with the application.

It some embodiments, it is desirable to have multiple applicators introducing the metal catalysts and chemical oxidizers into the shredder. Desirable there will be applicators both upstream and downstream of the shredder head. For example, in one embodiment, there may be as many as 6 applicators downstream of the shredder head, and as many as two or even more applicators on each side of the shredder head.

An addition of a hopper feeder system may be employed with the shredder to regulate and get a better and more complete application of the metal catalyst to the contaminated soil. For example, in one embodiment a single rail system having about 5 applicators may be used, but in an alternative embodiment, a dual rail with about 12 applicators may be employed.

Once past the shredder, the contaminated soil which has already been mixed with the metal catalyst and chemical oxidant is introduced into a sand screw. Sand screws are devices known to be useful in the art of conveying sand, small stones such as gravel, clays and the like. A sand screw mainly stirs the materials introduced therein (such as sand and gravel) through the screw device in the process often mixing the material with water until discharged from the device, often through a discharge port.

In another embodiment, the first stage of the system of the application includes as many as or even more three high pressure treating agent applicators mounted inside the mixing drum directly above a high-speed shredder head configured to treat the contaminated materials in an aerated state. In a second, the materials are mixed with the metal catalyst and chemical oxidant. In some embodiments, once the contaminated soil, catalyst, and chemical oxidant have been mixed, unwanted materials may be discharged. In some embodiments, this can occur in or just after the shredder. In other embodiment, it can occur at the of the system.

During many embodiments of the application, additional chemical oxidants can be added. For example, additional chemical oxidants may be introduced into the contaminated soil as it exits the shredder and/or as it enters the sand screw. If there are two sand screws, then additional chemical oxidants may be employed at the entrance of the second sand screw.

During employment of the systems of the application, sufficient metal catalyst is employed to achieve the desired level of remediation. In some embodiments, the reaction catalyzed by the metal catalyst may persist for as much as 12 hours or perhaps longer. Care should be employed that an exotherm if any, occurring within the treated soil does not become a hazard.

In one embodiment, the system of the application is employed to achieve what the remediation market needs to be able to remediate soils while also meeting the current challenges and regulatory agencies requirements for cleaning up contaminants in soils. For some soils, there may be as many as 12 applicators employed downstream of the shredder head. Desirably, for example, there will be sufficient applicators surrounding the shredder head for a complete 360 degree treating of the material, while it is in the aerated state.

The systems of the application are desirable easily configurable to match the requirement to treat a target contaminated soil. For example, for contaminated oils that are very difficult to treat, the system may be upgraded from a single rail 5 applicator point to a dual rail having from about 6 to about 20 applicators. In some embodiments, there are 8 applicators. In other embodiments there are about twelve applicators. This improvement allows for treating larger quantities of materials which in turns minimizes or at least mitigates the need to slow down production rates.

In addition to the components listed hereinabove, more components may be added to the system. For example, a sand screw that can process up to 400 tons per hour with a dual rail 12 applicator system may be employed. This increases the time that the material is treated within the system. It also provides addition mixing, grinding, and breakdown of contaminants such as wax, paraffins, and tar balls in the soil.

As already noted above, a second sand screw can be employed. Once the material being treated goes through the first sand screw it may be sent through a second sand screw where the materials are given an additional chemical oxidant treatment.

When exiting the sand screw or, in systems having second sand screw, the now treated soil can be introduced into a classifier and or separator. When the classifier is a screen, solids such as paraffins and tar balls (aka bitumen) can be redirects to a tank or bin for recycling in applications such as pavement or shingle production.

When the classifier is a liquids separator, clean water can be recycled back into the system or for another reuse. If there is a recoverable organic phase, it can be burned for fuel or otherwise recycled.

In some embodiments of the systems of the application, clean water, with or without chemical additives may be employed. One objective of the systems of the application is to remove any of the wax and paraffins or other contaminates that are still present in the soils that are remediating the systems of the application. Enhanced remediation may be achieved, in some applications, by introducing water into the contaminated soil. While the water may be introduced at any point in the application, is desirable is introduced at the entrance to one or both of the sand screws. In one embodiment, the water may include chemical additives which might enhance the separation of hydrocarbons from the soil to which that may be adhering.

One such chemical additive would be surfactants. A surfactant is an amphiphilic substance that has both a hydrophilic group that is easily soluble in water and a hydrophobic group that is easy to dissolve in oil in one molecule. It is a compound that significantly changes the properties of the interface by lowering the free energy. Surfactants are largely divided into chemically synthesized chemical surfactants and natural surfactants. Chemical surfactants include anionic surfactants, cationic surfactants, amphoteric surfactants, nonionic surfactants, and polymeric surfactants. Natural surfactants include lecithin, lanolin, saponins, and biosurfactants extracted from microorganisms. Emulsion polymers having surfactant properties can also be used. Surfactants useful with the systems of the application include but are not limited to these but also include any known to be useful to those of ordinary skill in the art.

In regard to other contaminants, undesirable metals could be such contaminants. In soils that have undesirable levels of metals, a chelant may be employed. A chelant, sometimes referred to as a sequestrant or a builder, is a specialized molecule designed to bind to positively charged metal ions, most commonly calcium and magnesium, in solution and thereby prevent these ions from forming insoluble precipitates with other ions that may be present. Some useful chelant may include EDTA, ethylene diamine, and porphine. Any chelant known to be useful to those of ordinary skill in the art may be employed with the methods of the application.

In employing the methods of the application, in some embodiments, once the materials have gone through system, an operator may perform field tests to check the contamination levels. If the tests show that the desired level of remediation has not reached, then a tilling machine that can aerate the soil may be employed. This aeration allows more oxygen to be exposed to the materials and keeps the oxidation process working for a longer period of time.

While the embodiments disclosed herein are primarily directed to soil remediation, the invention may also be employed to treat drill cuttings, and the like.

The embodiments of the application are primarily directed to remediating soils contaminated with crude oil, but the invention may also be used to remove or mitigate refined crude oil such as condensate, diesel, gasoline, amines, lubricating oils, chlorides, metals, and the like.

Tuning now to FIG. 1, 100 is an illustration of an embodiment of the system of the application. 101 is a shredder. 102 is a first sand screw. 103 is a second sand screw. 104 is a separator. 110 is a source of supplies of metal catalyst and chemical oxidant. 114 is a source of chemical oxidant and/or water and/or chemical additive.

105 is a feed stream of contaminated soil. 106 is the feed from the shredder which is feeds into the first sand screw. 107 is the feed from the first sand screw which feed into the second sand screw. 108 is the feed from the second sand screw which feeds into the separator. 109 is the product of the process.

111 is source of metal catalyst and/or chemical oxidant. 112 is a source of chemical oxidant and/or water and/or chemical additive.

In one embodiment of the invention, a contaminated soil 105 is fed into the shredder 101 where it is admixed with both a chemical oxidant, such as hydrogen peroxide, and a metal catalyst such as 1-0-1 iron and potassium fertilizer. The resultant partially treated contaminated soil 106 is the fed into the first sand screw 102. At this point additional chemical oxidant is introduced into the partially treated contaminated soil. In some embodiment, additional water and/or chemical additive is introduced into the partially treated contaminated soil producing a further treated contaminated soil 107. Again, at this point additional chemical oxidant is introduced into the partially treated contaminated soil. In some embodiment, additional water and/or chemical additive is introduced into the partially treated contaminated soil producing a further treated contaminated soil 108. This material is fed into the separator 104.

Within the separator, a stream of organic solids 109 may be produced. In other embodiments, a liquid stream is produced 109 which may have an organic phase and a water phase. All three of the streams may be discarded or recycled.

It should be noted that an operator can selectively deliver water and or chemical additives to none, one or both of the sand screws. One of ordinary skill in the are will be well able to determine when to add or not add these compositions to the system of the application.

In all embodiments a stream of treated soil which is at or near the point of being of acceptable quality for use in agriculture or construction. In some embodiment, where the remediation is not quite finished, a tiller (not shown) may be employed to further aerate the soil for increased remediation.

### EXAMPLES

### Example 1

About 150 tons of contaminated soil was treated using the system set forth in the FIGURE over 7 days. From a starting total petroleum hydrocarbon (hereinafter TPH) of 7.98%, the remediated soil from the first day had an observed TPH of 0.61%.

### Examples 2-7

The test of Example 1 was repeated with samples taken once each day during the run with all samples having a starting TPH of 7.98% and results for the treated soil ranging from about 0.60 to about 0.75.

### Example 8

The samples for days 1-7 were composited and had a value of 0.59 resulting a reduction of about 92%.

What is claimed is:

1. A system for remediating contaminated soil comprising a shredder, a sand screw, and a separator wherein:
the shredder is configured to:
receive a feed stream of contaminated soil;
introduce a metal catalyst and chemical oxidant into the shredder; and
feed the contaminated soil into the sand screw,
the sand screw is configured to:
receive a feed stream of partially treated contaminated soil;
receive a feed stream of chemical oxidant;
receive a feed stream of water and/or chemical additive; and
feed the contaminated soil into the separator, and
the separator is configured to:
separate the contaminated soil fed into it into at least a treated soil stream and an organic solids and/or liquids stream.

2. The system of claim 1 where in the sand screw is a first sand screw and further comprising a second sand screw configured to receive contaminated soil from the first sand screw.

3. The system of claim 2 wherein the second sand screw is configured to receive a feed stream of chemical oxidant; receive a feed stream of water and/or chemical additive; and feed the contaminated soil into the separator.

4. The system of claim 1 wherein an operator can selectively deliver water and or chemical additives to none, one or both of the sand screws.

5. The system of claim 1 further comprising a hopper configured to feed contaminated soil into the shredder.

6. The system of claim 5 where in the hopper can be configured to control a flow rate of the contaminated soil fed into the shredder.

7. The system of claim 1 wherein the separator is a screen which separates solids from the contaminated soil.

8. The system of claim 7 further comprising a separator configured to separate liquids from the contaminated soil.

9. The system of claim 1 further comprising a tiller which is configured to accept treated contaminated soil and further aerate the soil exiting the system.

10. A process for remediating contaminated soil comprising employing the system of claim 1 to remediate the contaminated soil.

11. A process for remediating contaminated soil comprising employing the system of claim 2 to remediate the contaminated soil.

12. The process of claim 11 wherein a metal catalyst is employed.

13. The process of claim 12 wherein the metal catalyst is an iron fertilizer.

14. The process of claim 13 wherein a chemical oxidant is employed.

15. The process of claim 14 wherein the chemical oxidant is hydrogen peroxide.

16. The process of claim 15 wherein a chelant is employed.

17. The process of claim 15 wherein contaminated soil is soil which has been contaminated with crude oil.

18. The process of claim 15 wherein the contaminated soil has been contaminated with a refined crude oil.

19. The process of claim 11 comprising employing a chemical additive.

20. The process of claim 19 wherein the chemical additive is a surfactant.
